(19) United States
(12) Patent Application Publication
(10) Pub. No.: US 2013/0226972 A1
(43) Pub. Date: Aug. 29, 2013

(54) METHODS AND SYSTEMS FOR PROCESSING DATA ARRAYS USING BLOOM FILTERS

(71) Applicants: Ramakumar Kosuru, Austin, TX (US); Chetan Kumar Gupta, San Mateo, CA (US); Choudur Lakshminarayan, Austin, TX (US)

(72) Inventors: Ramakumar Kosuru, Austin, TX (US); Chetan Kumar Gupta, San Mateo, CA (US); Choudur Lakshminarayan, Austin, TX (US)

(21) Appl. No.: 13/406,478

(22) Filed: Feb. 27, 2012

(51) Int. Cl. G06F 7/00

(52) U.S. Cl. 707/802; 707/E17.044

(57) ABSTRACT

The present disclosure relates to computing techniques. Data arrays are processed using Bloom filters to determine aggregate count, maximum, and minimum. These methods can be used on different types of data, including data groups, partial groups, data cubes, hypercubes, and others.

### BACKGROUND

The present disclosure generally relates to data processing methods and systems.

Since the invention of computer, the processing power of computer systems continues to improve, more or less following the famous Moore's Law. With ever increasing computing power, more and more data intensive applications are being developed. It is now not uncommon to see a database that stores many billions records running into peta bytes of data storage. Often, it is desirable to quickly analyze the data to obtain interesting information.

### BRIEF DESCRIPTION OF THE DRAWINGS

FIG. 1 is a simplified flow diagram illustrating setting up a Bloom filter for determining aggregate value.

FIG. 2 is simplified flow diagram illustrating using Bloom filter to determine aggregate value.

FIG. 3 is a simplified flow diagram illustrating setting up a Bloom filter for determining aggregate maximum value.

FIG. 4 is simplified flow diagram illustrating using Bloom filter to determine maximum value.

FIG. 5 is a simplified flow diagram illustrating setting up a Bloom filter for determining aggregate minimum value.

FIG. 6 is simplified flow diagram illustrating using Bloom filter to determine minimum value.

FIG. 7 is a simplified flow diagram illustrating partials groups for determining minimum aggregate using Bloom filters.

FIG. 8 is a simplified flow diagram illustrating using Bloom filter for group-set computation in a partial cube.

FIG. 9 is a simplified diagram illustrating a method for aggregate computation where an annotated Bloom filter is also shown.

FIG. 10 is a simplified diagram illustrating a suitably configured computer that can be used to execute the methods illustrated in FIGS. 1-9 and described above.

### DETAILED DESCRIPTION

The present disclosure generally relates to data processing. Bloom filters are used to process data at high speed. A Bloom filter can be used to quickly determine count, maximum, minimum, and/or other properties of a data array. The data array can have multiple rows where each row of data comprise three or more attributes. Other types of data arrays (such as rows of a table or rows from streams) can be processed as well.

As the size of datasets for analysis explodes, finding summaries quickly in a data array or a data cube assumes increased importance. These summaries are often computed in form of aggregates. Aggregations summarize the datasets through the group-by, the grouping-set, and the roll-up operations. The grouping operations could be computed either at an online analytical processing (OLAP) layer or at a database management system (DBMS) layer of an analytics engine. The construction of a data cube and even a partial cube of these aggregates is an expensive operation and most of work concentrates on exact computation, and where quick approximate results are required, the standard techniques are not sufficient. For example, an executive who wants a quick idea of performance of a certain product is primarily interested in a ballpark number to make sure that there are no surprises. In fact, in many situations quick answers are preferred even if they are approximate to precise answers that may take longer time. It is to be appreciated that the present disclosure provides simple techniques for fast approximation computations of these aggregates. Unfortunately, existing techniques do not provide single body of work that could quickly provide approximate values of maximum (MAX), minimum (MIN), and count (COUNT) functions for data arrays, in a data cube or a partial cube.

As an example, for a given a dataset with three attributes C₁, C₂, and C₃ per row of data, it is often desirable to perform a grouping-set online analytical processing (OLAP) operation and give out values of an aggregate function for every group. The aggregate functions such as the COUNT(*), the MAX, and the MIN can be computed using a Bloom filter.

In database parlance, each distinct value of an input represents a group. A group-by operation collapses the input into groups and computes a corresponding aggregate function and the grouping-set operation and the roll-up operation use the group-by operation as a basis for computing groups. By using Bloom-filter based algorithms to compute approximately the groups of an input with the corresponding aggregates, aggregate functions and the grouping-set operation can be performed quickly.

It is to be appreciated that a Bloom-filter based algorithm, as described in the present disclosure, is good for computing many distinct values of a population, and compares favorably to the traditional hash or sort based implementations. Algorithms for computing a group-by operation are presented using an annotated Bloom filter. With the annotated Bloom filter, updating the aggregates value of the group is quick when an input value is given. The present disclosure presents an algorithm (Bloom-Aggregate) that computes the aggregates in the annotated bloom filter. Due to false positives, the grouping aggregates are not 100% accurate but the number of false positives is low for a well-designed Bloom filter.

The error rate becomes unacceptable when the number of l's in the Bloom filter exceeds a threshold (say 30%-50%). The second algorithm (Bloom-Groups) takes this into account to reduce the error rate. When this happens, the Bloom-Groups algorithm stores partial groups on disk and reinitializes the Bloom filter (that is, reset bitmap and counters or accumulators to zero) and the remaining input is consumed to construct partial groups. To get the final answer, these partial groups are then fed to a traditional hash-based grouping implementation but with fewer inputs than before.

Developed by Burton Howard Bloom in 1970, Bloom filters are widely used probability data structures that can be used to test whether an element is a member of a set. For example, let there be an m bit vector where each bit is set to zero, this vector is used as a Bloom filter. Besides the Bloom Filter, we store an auxiliary structure with m counters that can store integers instead of just 0's and 1's to compute/store the aggregate value for all groups. Then, let there be n input values to encode in the filter. Assume that we have k hash functions. Each hash function hᵢ takes a column value v as input and outputs a number in {1 . . . m}. We set hᵢ(v)^{th} bit in the vector to one for each i ranging from 1 to k. Whenever hᵢ(v)^{th} bit is accessed we increment the corresponding counter (or accumulator) in the auxiliary structure. We take a function of the k counters (or the k accumulators) as our aggregate for a given group. For example, for the aggregate COUNT, the function could be the minimum value of the k counters.

Bloom filters are used to test membership queries. To test if a value v is already present in the filter we could apply the k hash functions on the value. If any of the k bits from the filter return zero, then the value v does not exist in the filter (that is, it is not a member).

There is a small but non-zero probability that the value does not exist but we may conclude that it does because all k bits are set to one. This false positive probability p is computed by

p=(1−ê(−kn/m))^{k} (Equation 1)

For a desired set of p, n, k values we can calculate number of bits needed (m) using the formula:

m=−kn/(ln(1−p̂1/k)) (Equation 2)

If we set n to be one million column values and set p to be 0.001, and k=5 then m needed is 16.48 MB. If we increase p to 0.01 then m is 9.39 MB. The more memory we have the more accurate bloom filter.

It is to be appreciated that one advantage of Bloom filters, despite possible false positives, is being able to be executed very quickly compared to many other types of methods, and the present disclosure describes methods for using Bloom filter to compute COUNT, MAX, and MIN functions.

For COUNT, MAX, and MIN functions, Bloom filters can be used in conjunction with hash functions. The Bloom filter performance may depend on availability of fast hash functions. As an example, an array S of 255 random values is constructed. The random values can be obtained from www.random.org, or can be generated by a pseudo random number generator with the restriction that each generated value is in range {0 . . . 255} inclusive, so that each value requires at most one byte of storage space. For example, for a hash function that returns a 64 bit unsigned integer, the following pseudo code can be used for the implementation For example, the hash function takes a string of characters as input and returns a 64 bit unsigned integer as output:

```
unsigned long Hash1(char * str)
{
// use identity I & 7 = I mod 8 where & is bitwise AND and mod is a
modulo function
  unsigned char h[ ]={0,15,127,255,31,131,199,249};
// h is 8-byte character array populated with random values; each value is
// less than 256.
  for(int i = 0; str[i] !=‘\0’; i++)
  {
    h[i&7] = S[(h[i &7]) \hat{ } (str[i])];
  }
  // \hat{ } : bit wise XOR
  return (h[3] << 24) + (h[2] << 16)+(h[1]<<8)+h[0]+
            (h[6]<<48)+(h[5]<<40)+(h[4] << 56) + (h[7] << 32);
}
```

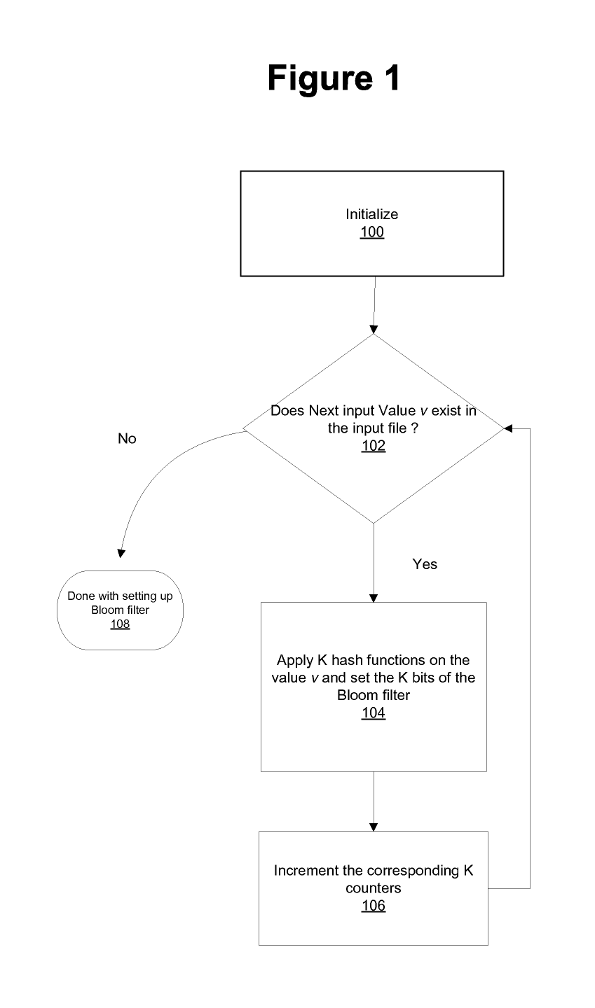

To use a Bloom filter for these functions, the Bloom filter needs to be generated. FIG. 1 is a simplified flow diagram illustrating setting up a Bloom filter for determining the aggregate value COUNT. This diagram is merely an example, which should not unduly limit the scope of the claims herein. One of ordinary skill in the art would recognize other variations, modifications, and alternatives. Depending on the implementation and/or application, various steps can be added, removed, modified, repeated, replaced, rearranged, and/or overlapped. At step 100, various parameters are provided and a Bloom filter is initialized. Based on an input file, an array of input values v's is selected. The Bloom filter is initialized based on its size. To generate the Bloom filter, k hash functions are used. At step 102, the input file is processed to determine if the next input value v exists in the input file. If so, step 104 is performed, in which k hash functions are applied on the value v and k bits of the Bloom filter is set. After step 104 is performed, corresponding k counters are incremented at step 106. The processes goes back to step 102 once step 106 is performed. Where at step 102 it is determined that the next input value v does not exist in the input file, Bloom filter generation processed is complete and stops at step 108. The Bloom filter generated according to the flow diagram in FIG. 1 can be used for determining the COUNT aggregate.

For example, to determine an aggregate using the Bloom filter, the following steps are performed:

1. Consume an input file and set the Bloom filter.

2. Maintain an auxiliary structure (e.g., counters or accumulators) to Bloom filter bit vector to maintain state for each group. A simple counter would suffice for the count (*) aggregation. If we use k hash functions for the Bloom filter, we increment the k counters a given group hashes to. For a MAX aggregate function we keep 2-byte state information. K such objects are used. In the case of MAX or MIN aggregate, we take mode value of K values to be the aggregate value.

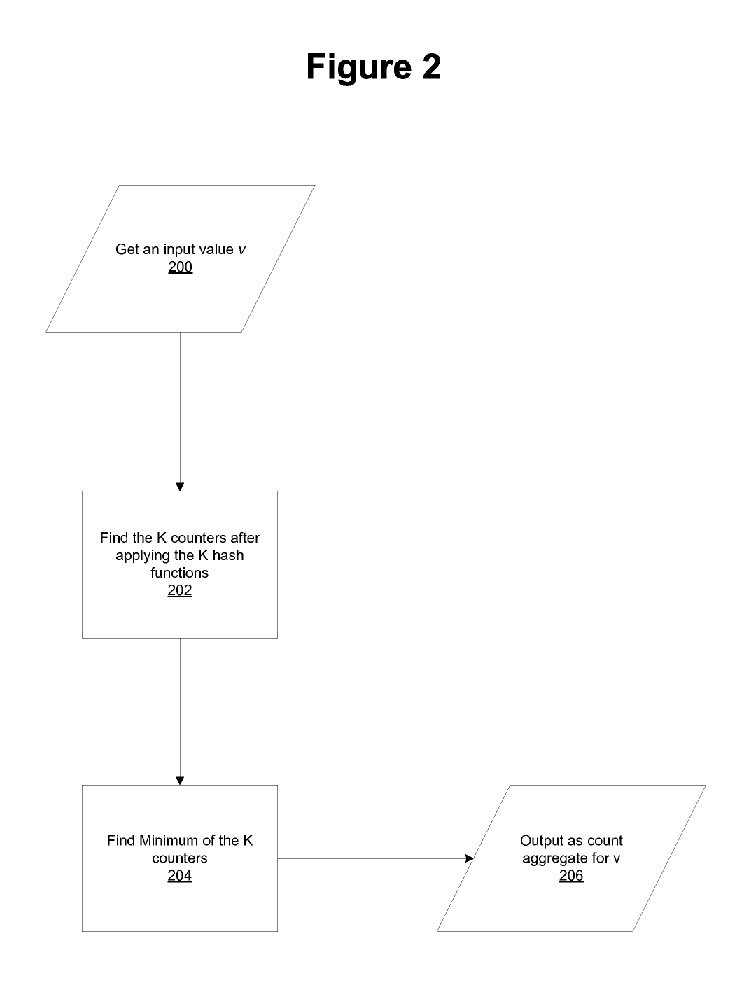

FIG. 2 is simplified flow diagram illustrating using Bloom filter to determine the aggregate value COUNT. This diagram is merely an example, which should not unduly limit the scope of the claims herein. One of ordinary skill in the art would recognize other variations, modifications, and alternatives. Depending on the implementation and/or application, various steps can be added, removed, modified, repeated, replaced, rearranged, and/or overlapped. As an example, for determining the aggregate value, the Bloom filter generated according to the flow diagram in FIG. 1 is used. At step 200, an input with a value v is received. For example, the goal of using the Bloom filter is to determine how many value v's are in a data array. Once an input value v is obtained, k hash functions are applied at step 202, and k counters are founded. At step 204, the minimum of k counters is found. At step 206, the counted aggregate is outputted, which is the minimum of k counters.

To provide an example, computing approximate aggregation uses the function count(*) function. Assume that m is 14 bits and that there are three hash functions (i.e., k is 3). Now assume that input “25” comes in and gets hashed to indices 13, 8, and 4. The corresponding counters are incremented and bits in the bitmap are set to one. When an input “92” comes in as input and gets mapped to indexes 8, 4, and 3 by the three hash functions. If the next input is again “25”, the Bloom filter updates as the counters 13, 8, and 4 are incremented. The aggregate value for group “25” is given by minimum of counter values at 13, 8, and 4. In this case, counters 4 and 8 has the value of 3 (i.e., incremented from both inputs “25” and “92”), and the counter 13 has a value of “2”. The value “2” is the minimum among the three counters. For the input v=25 (i.e., querying how many “25” inputs are in there), the count aggregate is 2, as there were 2 input values of 25.

It is to be appreciated that methods for determine aggregates using Blooming filter can provide significant speed advantages over other types of methods (e.g., Hash operation). The accuracy of the aggregate or COUNT function can be close to 100%. As an example, in performing a group-by operation on 20 million strings after choosing a high number of groups for the experiment, that false positives go up as groups go up. A join operation is performed between the Bloom filter and the output of groups, and hash-map implementation of aggregate values. The value match is provided between the hash-map implementation and the Bloom filter implementation. Accuracy of the Bloom filter is 98% in this case. In this example, 40 million bits for m is used to measure accuracy. The mismatched aggregate values are higher than they should be due to false positives. No partial groups are rewritten to disk for the Bloom filter based algorithm. The k of 5 is used. The result is summarized in Table 1 Below:

TABLE 1

| | | Elapsed | | | |
|---|---|---|---|---|---|
| | # of Groups | Time | Memory | | Input Size |
| Algorithm | (million) | (Seconds) | in MB | Accuracy | (million) |
| Hash | 19.8 | 98 | 722 | 100% | 20 |
| Bloom | 19.7 | 56 | 767 | 98% | 20 |

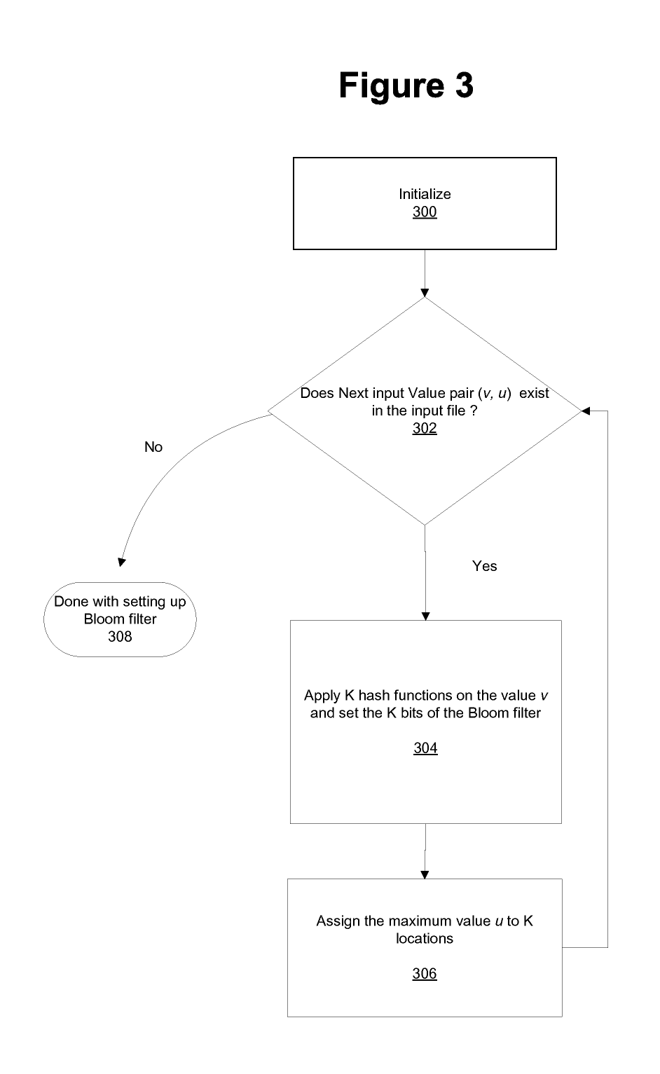

Bloom filter can be used to determine maximum value as well. To use Bloom filter for MAX operation, a Bloom filter for aggregate maximum may be needed, where the MAX operations determines the maximum u for group value v. FIG. 3 is a simplified flow diagram illustrating setting up a Bloom filter for determining aggregate maximum value. This diagram is merely an example, which should not unduly limit the scope of the claims herein. One of ordinary skill in the art would recognize other variations, modifications, and alternatives. Depending on the implementation and/or application, various steps can be added, removed, modified, repeated, replaced, rearranged, and/or overlapped. At step 300, various parameters are provided and a Bloom filter is initialized. Based on an input file, an array of input value pairs v's and u's, or value pair (v, u), is selected. The Bloom filter is initialized based on its size. To generate the Bloom filter, k functions are to be used. At step 302, the input value pairs (v, u) are processed to determine if the next input value pair (v, u) exists in the input file. If so, step 304 is performed, in which k has functions are applied on the value v and k bits of the Bloom filter are set. After step 304 is performed, the maximum value u is assigned to k locations at step 306. The processes goes back to step 302 once step 306 is performed. Where at step 302 it is determined that the next input value pair (v, u) does not exist in the input file, Bloom filter generation processed is complete and stops at step 308. The Bloom filter generated according to the flow diagram in FIG. 3 can be specifically used for determining maximum.

As an example, one operation is to compute maximum value of an attribute for a given group. Members of the group are stored in column C, and the goal is to compute maximum value for column D in the group. A state object is used for each bit to store the corresponding maximum. For k=3, a maximum in the 3 objects is stored. If the object is already used, the object is overwritten with the current maximum. Maximum for a given group is determined by mode value of the 3 objects. If there is no mode, the majority value is used. If there is no majority value, one value from the k objects is selected.

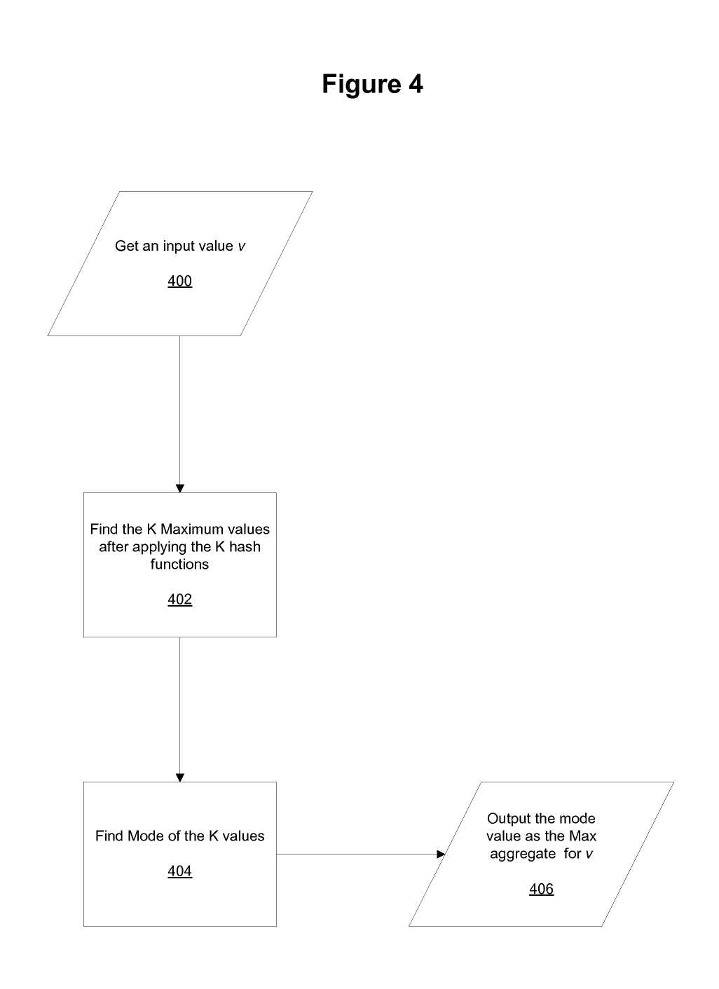

FIG. 4 is simplified flow diagram illustrating using Bloom filter to determine maximum value. This diagram is merely an example, which should not unduly limit the scope of the claims herein. One of ordinary skill in the art would recognize other variations, modifications, and alternatives. Depending on the implementation and/or application, various steps can be added, removed, modified, repeated, replaced, rearranged, and/or overlapped. As an example, for determining maximum value, the Bloom filter generated according to the flow diagram in FIG. 3 is used. At step 400, an input with a value v is received. Once an input value v is obtained, k hash functions are applied at step 402 to find k maximum values. At step 404, the mode of k values is determined. At step 406, the maximum value of aggregate is outputted, which is the mode value of k values.

Again, determining maximum (or MAX function) using Bloom filter can provide various advantages over other techniques. For example, in comparison to using hash function, the Bloom filter based MAX function can provide significant speed (i.e., faster) and memory (i.e., smaller) advantages, as demonstrated in a test case where there are 723 groups for an input size of 25 million, and each row has 3 attributes. The first two columns used as grouping columns, and MAX function is computed for third column. The parameter m is 12 million bits. The hash algorithm is stored on a disk for the maximum aggregate for each group along with the group. The Bloom aggregate algorithm used the file from disk to measure accuracy of the maximum function. The result and parameters are shown in Table 2 below:

TABLE 2

| | # of | Elapsed Time | Memory | | Input Size |
|---|---|---|---|---|---|
| Algorithm | Groups | (Seconds) | in MB | Accuracy | (million) |
| Hash | 723 | 57 | 53 | 100% | 25 |
| Bloom | 721 | 42 | 42 | 99.7% | 25 |

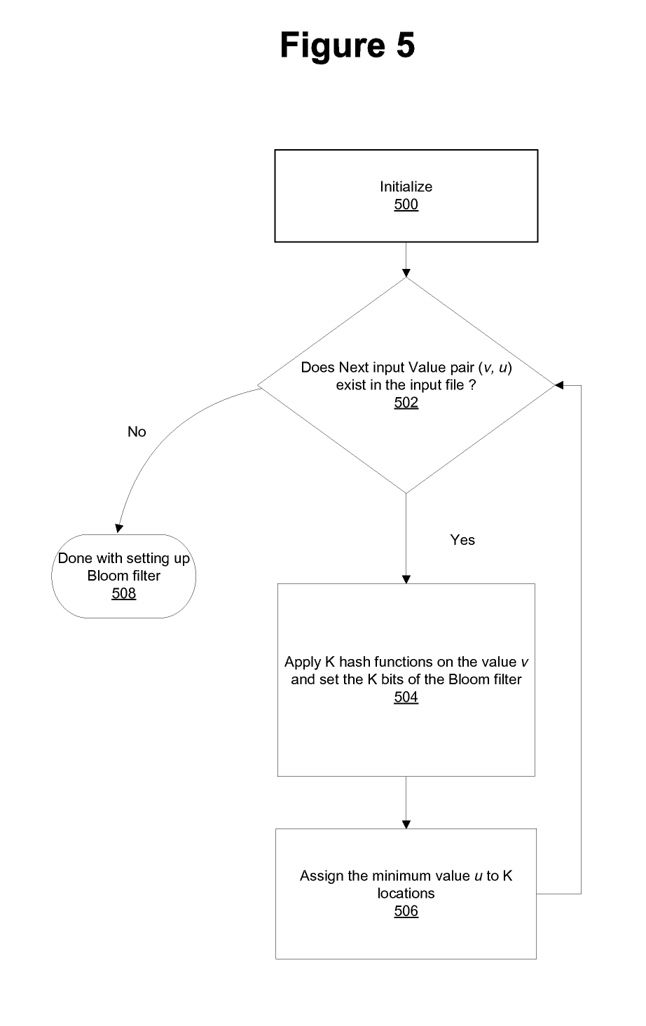

The Bloom filter can be used to determine minimum (or MIN function) as well. To use Bloom filter for MIN operation, a Bloom filter for aggregate minimum may be needed, where the MIN operations determines the maximum u for group value v. FIG. 5 is a simplified flow diagram illustrating setting up a Bloom filter for determining aggregate minimum value. This diagram is merely an example, which should not unduly limit the scope of the claims herein. One of ordinary skill in the art would recognize other variations, modifications, and alternatives. Depending on the implementation and/or application, various steps can be added, removed, modified, repeated, replaced, rearranged, and/or overlapped. At step 500, various parameters are provided and a Bloom filter is initialized. Based on an input file, an array of input value pairs v's and u's, or value pair (v, u), is selected. The Bloom filter can be initialized based on its size. To generate the Bloom filter, k functions are to be used. At step 502, the input value pairs (v, u) are processed to determine if the next input value pair (v, u) exists in the input file. If so, step 504 is performed, in which k has functions are applied on the value v and k bits of the Bloom filter are set. After step 504 is performed, the maximum value u is assigned to k locations at step 506. The processes goes back to step 502 once step 506 is performed. Where at step 502 it is determined that the next input value pair (v, u) does not exist in the input file, Bloom filter generation processed is complete and stops at step 508. The Bloom filter generated according to the flow diagram in FIG. 5 can be specifically used for determining minimum values.

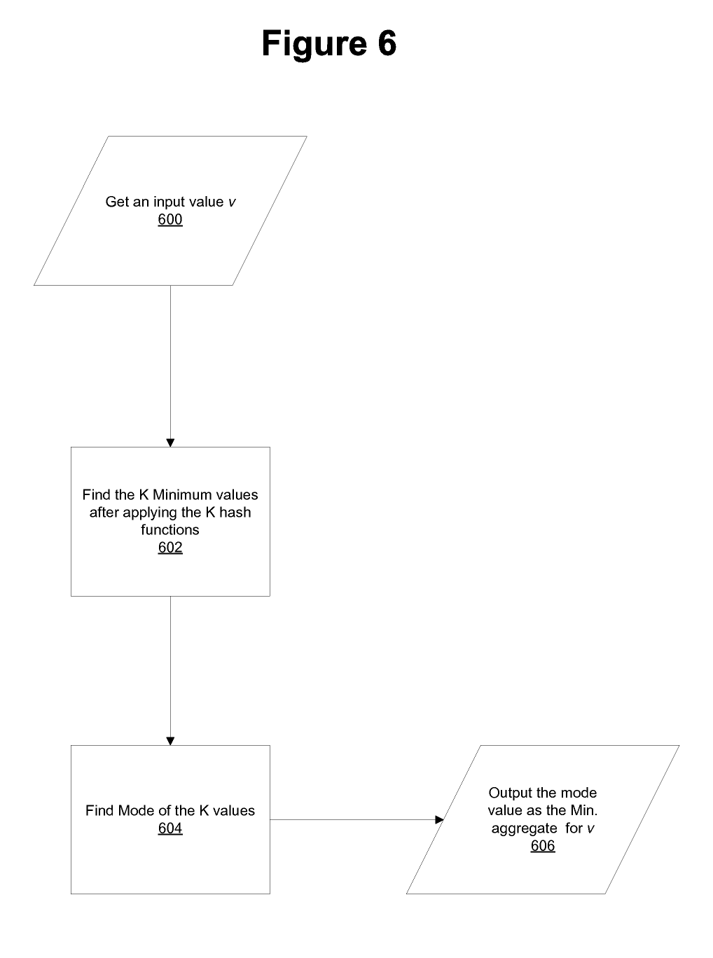

FIG. 6 is simplified flow diagram illustrating using Bloom filter to determine minimum value. This diagram is merely an example, which should not unduly limit the scope of the claims herein. One of ordinary skill in the art would recognize other variations, modifications, and alternatives. Depending on the implementation and/or application, various steps can be added, removed, modified, repeated, replaced, rearranged, and/or overlapped. As an example, for determining minimum value, the Bloom filter generated according to the flow diagram in FIG. 5 is used. At step 600, an input with a value v is received. Once an input value v is obtained, k hash functions are applied at step 602 to find k minimum values. At step 604, the mode of k values is determined. At step 606, the minimum value of aggregate is outputted, which is the mode value of k values. It is to be appreciated that by using Bloom filter, minimum value can determined quickly and efficiently.

The aggregate function provided with Bloomer filters can be used to store groups. Groups of data can be stored on disk so that partial groups could be computed for larger inputs. Storing groups of data on disk is sometimes needed, because Bloom filter bitmaps become less reliable as number of 1's increase in the bit map, which resulting in an increase in false positives. To overcome this, the bitmap is reinitialized. Before re-initialization, the partial groups are stored on the disk. A partial group refers to a group that is not fully collapsed so the group values repeated.

First, set S1 is built. The set S1 contains almost all distinct values (distinct value=group) by applying a Bloom filter on an input of column values and adding to S1 when the input column is not a member. Periodically, the groups are written to disk when the number of groups exceeds a specific value (for example, the specific value can be 2 million). When all input is consumed, or when the partial groups need to be stored (i.e., Bloom filter needs to be reinitialized), each member and the corresponding aggregate value are outputted to a file.

Since Bloom filter is re-initialized when density (e.g., density refers to percentage of 1's in the bitmap) exceeds a predetermined threshold (e.g., 30%-50%), it is not needed to have all the m counters at any given time. In practice, it may be enough to store 30%-50% of m counters. To increase accuracy, the higher number of bits per input value can be allocated (e.g., increasing the m/n ratio), which may result in an increase in storage requirement and a decrease in calculation speed.

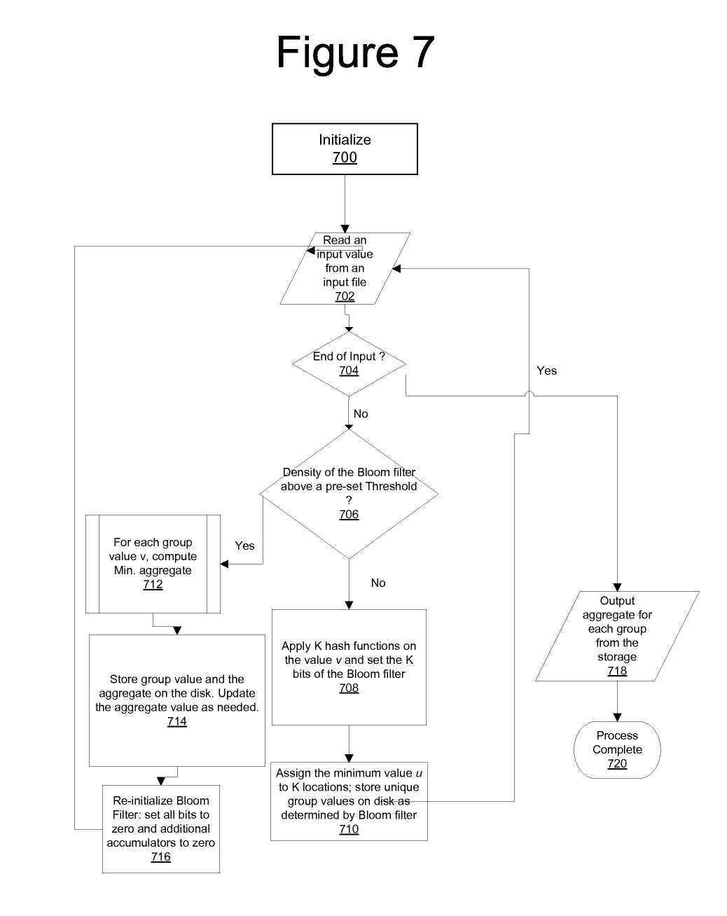

FIG. 7 is a simplified flow diagram illustrating partials groups for determining the minimum aggregate using Bloom filters. This diagram is merely an example, which should not unduly limit the scope of the claims herein. One of ordinary skill in the art would recognize other variations, modifications, and alternatives. Depending on the implementation and/or application, various steps can be added, removed, modified, repeated, replaced, rearranged, and/or overlapped. At step 700, a Bloom filter and various parameters related to the computation process are initialized. At step 702, an input value from an input file is processed. At step 704, it is determined whether the input file is at its end (e.g., reached EOF). If the input file is not at its end, step 706 is performed. At step 706, the Bloom filter is analyzed to determine if its density is above a predetermined threshold level. If so, step 712 is performed. At step 712, for each group value v, the minimum aggregate value is computed (e.g., as shown in FIG. 6). At step 714, group value and aggregate are stored on the disk. The storage structure can be a B-tree and/or other types of structures. The aggregate value is updated as needed. At step 716, the Bloom filter is re-initialized, where all bits and additional accumulators are set to 0. After step 716 is performed, step 702 is performed to process the next input value from the input file. Now referring back to step 706. If the density of the Bloom filter is not above the predetermined threshold value, step 708 is performed. At step 708, k hash functions are applied on the value v and set the k bits of the Bloom filter. At step 710, the minimum value u is assigned to k locations, and unique group values are stored on the disk as determined by the Bloom filter. After step 710 is performed, step 702 is performed to process the next input value from the input file. Now referring back to step 704. Once the end of the input file is reached (i.e., all input values are processed), step 718 is performed. At step 718, aggregate for each group from storage is outputted. At step 720, the process is complete.

Bloom filter can also be used for group-set computation in a partial cube. Suppose a grouping-set operation on columns (C₁, C₂) with column (C₃) is to be performed. The computation starts by splitting a row (C₁, C₂, C₃) into two different rows: (C₁, C₂) and (C₁, C₃) and feeding the two split rows to two Bloom operators. For example, a Bloom operator refers to a Bloom filter is that used to perform one or more operations, such as aggregate count, aggregate maximum, and/or aggregate minimum. Each Bloom operator performs a group-by operation. For example, one Bloom operator performs a group-by on columns C₁ and C₂, while another Bloom operator performs a group-by on columns C₁ and C₃. The two outputs from the two Bloom operators are used to compute union of two outputs. Each of the Bloom operators consumes input and writes out full groups or partial groups depending on whether the Bloom filter is reinitialized. If partial groups are output then these are fed to a hash-table based grouping implementation to finish the group-by operation.

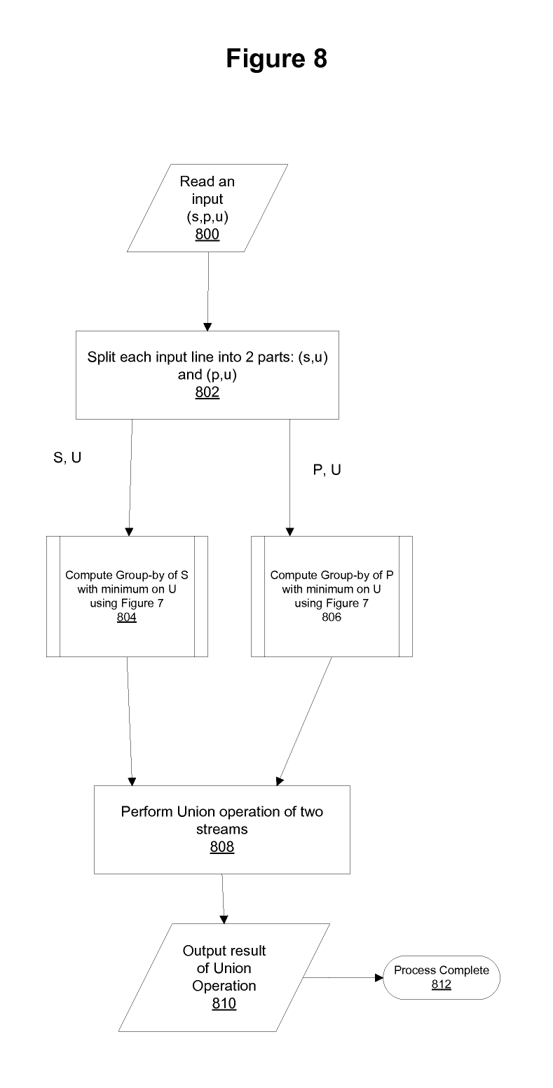

FIG. 8 is a simplified flow diagram illustrating using Bloom filter for group-set computation in a partial cube. This diagram is merely an example, which should not unduly limit the scope of the claims herein. One of ordinary skill in the art would recognize other variations, modifications, and alternatives. Depending on the implementation and/or application, various steps can be added, removed, modified, repeated, replaced, rearranged, and/or overlapped. As described above, a partial cube refers to a data structure having three or more arrays of data attributes. For example, a group set has attributes S, P, and U, where the set of (S,P) is grouped with (U). Assume that we are computing the minimum aggregate is to be determined. A database D has (S, P, U) for each row corresponding to S (supplier number), P (Part number), and U (number of units sold). At step 800, an input (s, p, u) is read. At step 802, each input line is split into 2 parts: (s, u) and (p, u). To process (s, u), at step 804, group-by of S is computed with minimum on U using the processed illustrated in FIG. 7. Similarly, at step 806, group-by of P is computed with minimum on U using the processed illustrated in FIG. 7. At step 808, union operation for the two streams of processes (step 804 and step 806) is performed. At step 810, the result from step 808 is outputted, and the process is completed at step 812.

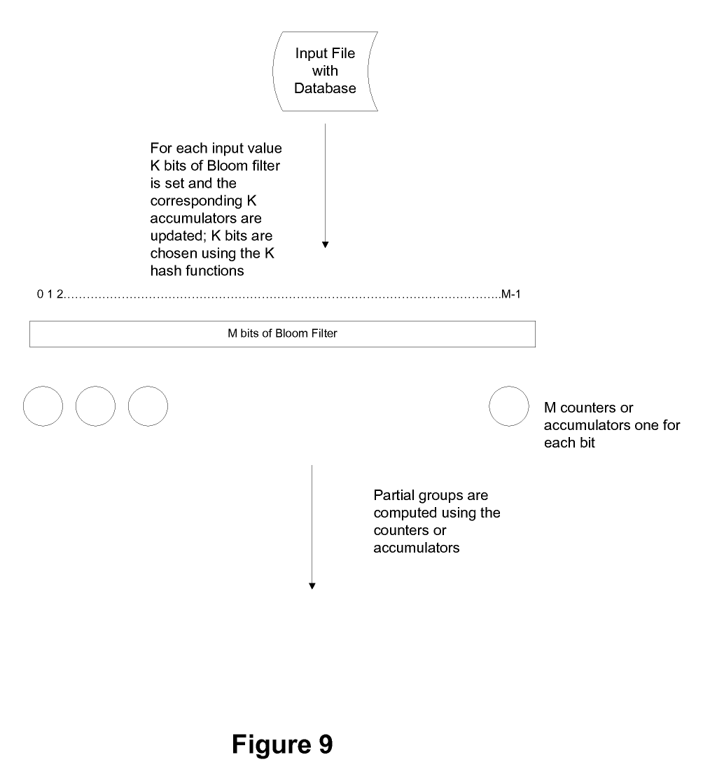

Using Bloom filters, other operation are possible in addition to aggregate, maximum, and minimum. For example, by using Bloom filters that split in n streams, a various operations can be performed on n dimension hypercubes. FIG. 9 is a simplified diagram illustrating a method for aggregate computation. This diagram is merely an example, which should not unduly limit the scope of the claims herein. One of ordinary skill in the art would recognize other variations, modifications, and alternatives. As shown in FIG. 9, an m bit Boom filter and m counters are used to process input files. For each input value, k bits of Bloom filter are set and the corresponding k accumulators are updated, and k bits are chosen using the k hash functions. Partial groups are computed using the counters.

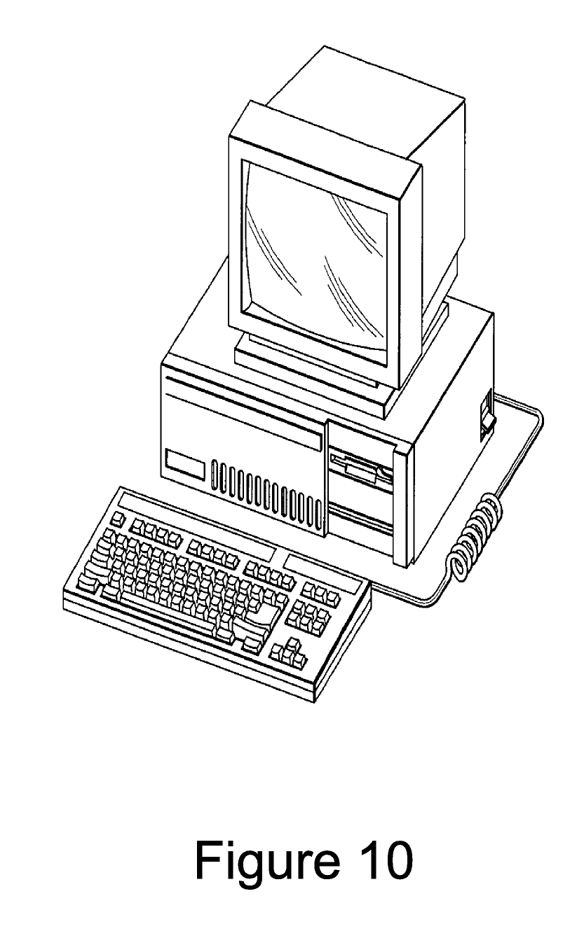

It is to be appreciated that the methods and processes described above can be implemented using various types of computing system, and the algorithm can be stored on various types of computer readable mediums. FIG. 10 is a simplified diagram illustrating a suitably configured computer that can be used to execute the methods illustrated in FIGS. 1-9 and described above. This diagram is merely an example, which should not unduly limit the scope of the claims herein. One of ordinary skill in the art would recognize other variations, modifications, and alternatives.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method for determining an aggregate value, the method comprising:
providing an input file, the input file being stored on a computer readable medium;
initializing a Bloom filter using at least the input file, the Bloom filter comprising a m number of bits and m counters;
providing an input value;
providing k counters;
applying k number of hash functions with the Bloom filter;
updating the k counters based on k bits of the Bloom filer;
analyzing the k counters;
determining a minimum value of k counters; and
providing an aggregate value based on the minimum value.

2. The method of claim 1 further comprising:
processing the input file, the input file comprising a first value;
performing k number of hash functions on the first value;
setting k bits of the Bloom filter.

3. The method of claim 2 further comprising incrementing the k counters.

4. The method of claim 1 wherein further comprising storing the Bloom filter on the computer readable medium.

5. The method of claim 1 wherein the k counters correspond to the k number of bits of the Bloom filter.

6. A method for determining a maximum value, the method comprising:
providing an input file, the input file being stored on a computer readable medium;
initializing a Bloom filter using at least the input file, the Bloom filter comprising a m number of bits and m counters or accumulators;
providing an input value;
applying k hash functions with the Bloom filter;
determining k number of maximum values;
determining a mode of k maximum values; and
providing a maximum value based at least on the mode of k maximum values.

7. The method of claim 6 further comprising:
processing values pairs of the input file, each of the value pairs having a first value v and a second value u;
applying k hash functions on the first value v;
setting the k bits of the Bloom filter;
assigning the second value u to k locations.

8. The method of claim 6 further comprising storing the Bloom filter on a computer readable medium.

9. The method of claim 6 wherein the input file comprises data arrays.

10. The method of claim 6 wherein the input value is associated with a data array.

11. A method for determining a maximum value, the method comprising:
providing an input file, the input file being stored on a computer readable medium;
initializing a Bloom filter using at least the input file, the Bloom filter comprising a m number of bits;
providing an input value;
applying k hash functions with the Bloom filter;
determining k number of minimum values;
determining a mode of k maximum values; and
providing a minimum value based at least on the mode of k maximum values.

12. The method of claim 11 further comprising:
processing values pairs of the input file, each of the value pairs having a first value v and a second value u;
applying k hash functions on the first value v;
setting the k bits of the Bloom filter;
assigning the second value u to k locations.

13. The method of claim 12 wherein the second value u comprises a minimum value.

14. The method of claim 11 further comprising:
determining a density for the Bloom filter;
re-initializing the Bloom filter is the density is greater than a predetermined threshold value.

15. The method of claim 11 wherein the input files comprise three or more data arrays.
